(19) United States
(12) Patent Application Publication
(10) Pub. No.: US 2024/0328205 A1
(43) Pub. Date: Oct. 3, 2024

(54) PADLOCK WITH VENDING CYLINDER

(71) Applicant: DYNAMIC MANUFACTURING GROUP LLC, PALMETTO, FL (US)

(72) Inventors: Ronald Lee, JR., Ruskin, FL (US); Anthony Sansone, Parrish, FL (US); Joshua Settle, Sarasota, FL (US)

(21) Appl. No.: 18/295,229

(22) Filed: Apr. 3, 2023

(51) Int. Cl. E05B 63/00; E05B 67/02; E05B 67/22

(52) U.S. Cl. CPC E05B 63/0056; E05B 67/02; E05B 67/22

(57) ABSTRACT

A padlock includes a body with a primary channel that rotatably receives a sleeved cam. The sleeved cam contains a vending style lock with a deployable lug. The lug aligns with a window in the sleeve of the sleeved cam and extends through the window into a lug compartment in the body when locked. The cam of the sleeved cam moves locking members (e.g., balls that mate with hemispherical notches in a shackle), when the sleeved cam rotates between locked and unlocked positions. The padlock may be rekeyed by replacing the lock plug.

### FIELD OF THE INVENTION

This invention relates generally to a padlock, and, more particularly, to a padlock that utilizes a vending style cylinder.

### BACKGROUND OF THE INVENTION

Locks are typically rekeyed when a key is stolen, lost, worn or damaged or when the owner wants assurance that a prior owner or user does not have a key. Rekeying a lock typically entails disassembly of the lock core (i.e., lock plug), including removing existing pins (i.e., key pins, and possibly driver pins) and possibly springs and replacing them with new ones that will work with a new or existing key. To rekey a padlock, the lock core must be removed. To remove the lock core, typically, the shackle must be opened. A screw or other retainer may be accessible through the open cylinder in which the free end of the shackle is received. Removal of the screw or retainer may release the lock core for removal. With the lock core removed, the pins and springs may be accessed and replaced.

Current padlocks are generally not easily rekeyable. In certain instances, padlocks are not rekeyable at all. Lock cores of some padlocks are not configured to be removed. For example, many padlocks include an extra driver pin and spring that engages a groove in the lock core to prevent removal of the lock core. The spring biases the pin towards the groove. For security reasons, such locks typically do not include means for accessing the pin to depress it, thereby releasing the lock core. To remove such a core, the pin must be defeated (e.g., broken), which can damage the interior structure of the padlock, making the padlock unusable.

Even when a lock core is removable, the process of rekeying is complicated. Typically, the lock core cannot be easily replaced. Thus, rekeying entails disassembly of the locked core. It is not a process that can be accomplished by just anyone and anywhere. It is a tedious process. The process involves small parts that can be tricky to handle and are easily lost. To successfully rekey a core, a person must have a suitable workspace where miniscule parts are not lost. The person must also have appropriate tools and knowledge of the process.

An easy to rekey padlock is needed. The rekeying process should be accessible to laypersons. The process should be one that can easily be performed at the site of the padlock, if necessary. The process should entail removal and replacement of the lock core with a lock core that is generally available in the marketplace. The padlock should be designed to work with such a lock core. The process of removal and replacement should be easy to do anywhere. The process should avoid any need to disassemble the lock core.

The invention is directed to overcoming one or more of the problems and solving one or more of the needs as set forth above.

### SUMMARY OF THE INVENTION

To solve one or more of the problems set forth above, in an exemplary implementation of the invention, a padlock includes a lock body (e.g., an integrally formed solid body) with a bottom and a top, a primary channel (e.g., a primary bore) extending through the bottom into the lock body, a pair of spaced apart parallel shackle channels (e.g., parallel shackle bores) extending through the top into the lock body. A sleeved cam is received in the primary channel. The sleeved cam includes a tubular sleeve, a cam fixed at an end of the sleeve and a window in the sleeve. The sleeved cam is rotatable in the primary channel, about a longitudinal axis, from a locked position to an unlocked position. A lock plug (e.g., a vending style lock with a tubular keyway) is disposed (e.g., contained) within the tubular sleeve. The lock plug includes a lug that is movable from a retracted position to an extended position. The lug is aligned with the window of the sleeve. The lug is about flush with the window in the retracted position and extends through the window in the extended position.

A lug compartment is provided in the lock body. The lug compartment is aligned with the lug when the sleeved cam is in the locked position. The lug extends into the lug compartment when the lug is in the extended position and the sleeved cam is in the locked position. The lug not extends into the lug compartment when the lug is in the retracted position. A shackle, which may have a J-shape, includes a shank, an intermediate section (e.g., a bend) and a free end parallel to the shank. The intermediate section extends from the shank to the free end. The shank and free end of the shackle are at least partially receivable in the pair of shackle channels.

A pair locking members (e.g., solid metal balls). The cam is positioned between one locking member and the other locking member. In the locked position, the cam urges one locking member against the free end and urges the other locking member against the shank of the shackle.

Each of the free end and the shank of the shackle includes a notch (e.g., a hemispherical notch). The notch of the free end is opposite the notch of the shank. In the locked position, the notch of the free end and the notch of the shank are aligned with the cam. In the locked position, the cam urges one locking member against the notch in the free end and urges the other locking member against the notch in the shank of the shackle. In the locked position, the cam urges one locking member against the notch in the free end and urges the other locking member against the notch in the shank of the shackle.

The tubular sleeve may also include a peripheral fenestration extending about 90° around the tubular sleeve. A threaded channel may be formed in the lock body, in alignment with the peripheral fenestration. A set screw may be received in the threaded channel, with the tip of the set screw extending into the peripheral fenestration. The tip of the set screw does not exert rotation preventing force against the vending style lock. If the set screw is over tightened and therefore prevents rotation, the set screw may be backed out (loosened) slightly to allow rotation without disengaging the fenestration.

If the lock body is a solid integrally formed structure, the primary channel may be a first bore, each shackle channel of the pair of spaced apart parallel shackle channels may be a second bore, and the lug compartment may be an undercut in one of the shackle channels of the pair of spaced apart parallel shackle channels.

The lock body may include a threaded access channel extending, in alignment with the cam, through one of the shackle channels of the pair of spaced apart parallel shackle channels.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of an exemplary padlock in an unlocked configuration according to principles of the invention; and

FIG. 2 is an isometric view of the exemplary padlock in a locked configuration according to principles of the invention; and

FIG. 3 is partial section view of the exemplary padlock in an unlocked configuration according to principles of the invention; and

FIG. 4 is partial section view of the exemplary padlock in a locked configuration according to principles of the invention; and

FIG. 5 is an isometric partial section view of the exemplary padlock in an unlocked configuration according to principles of the invention; and

FIG. 6 is another isometric partial section view of the exemplary padlock in an unlocked configuration according to principles of the invention; and

FIG. 7 is an isometric partial section exploded view of the exemplary padlock in an unlocked configuration according to principles of the invention; and

FIG. 8 is a section view of a padlock body of the exemplary padlock according to principles of the invention;

FIG. 9 is an isometric section view of a padlock body of the exemplary padlock according to principles of the invention; and

FIG. 10 is a plan view of locking mechanism components of the exemplary padlock according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

An exemplary padlock according to principles of the invention includes a removable vending style lock core that can readily be removed and replaced for rekeying, without compromising security. The lock core is received in a sleeved cam. The sleeved cam rotates with the lock core. Such rotation positions balls that engage or disengage notches in a shackle to lock and release. To remove the lock core, the core is unlocked and a set screw is removed, whereupon the lock core and sleeved cam may be slid from the body of the lock. Depressing a plunger of the unlocked lock core allows separating the lock core from the sleeved cam, whereupon the lock core may be replaced. Installation of a replacement lock core entails inserting the replacement lock core in the sleeved cam until the plunger engages a window in the sleeved cam. Then the sleeved cam containing the lock core is inserted into the body of the lock and aligned to allow the set screw to engage a peripheral fenestration in the sleeved cam. Then the set screw is reinstalled. The entire process takes but a few minutes, can be completed by any mechanically inclined person, does not require a special workspace or locksmith tools, and does not require removal of pins or springs from the lock core.

Tubular cylinder locks for vending machines (i.e., “vending style locks”) are ubiquitous. Many such locks have a lug that extends radially from the lock core when the lock is locked, and retracts towards the lock core when the lock is unlocked. When used on a vending machine, the lug extends into a small compartment of a body or behind a panel to achieve locking. In the present invention, the vending style lock is adapted to control rotation of sleeved cam that provides locking and unlocking action.

In contrast, a locking mechanism of a conventional padlock is typically a cylinder with a keyhole, which is turned by a key. Inside the cylinder is a set of pins that are lifted or lowered by the key to match the pattern of cuts on the key. When the correct key is inserted and turned, the pins align and the cylinder can turn. Unlocking rotation of the cylinder exerts force on a locking plate or locking latches, causing the locking plate or latches to move away from notches in the shackle. This movement allows the shackle to be opened.

A padlock according to principles of the invention adapts a vending style lock to a padlock. The adaptation utilizes a sleeved cam, the sleeve of which receives the vending style lock is received. A movable lug of the vending style lock aligns with a window in the sleeve.

When locked, the lug extends through the window. When unlocked, the lug is about flush with the window. The sleeve also includes a narrow peripheral fenestration that extends 90° around the sleeve. A tip of a set screw extends into the fenestration, but does not exert force against the sleeve (or the contained vending style lock) that would prevent rotation of the sleeve (and the contained vending style lock) relative to the set screw. The 90° span of the fenestration allows rotation of the sleeve (and the contained vending style lock) 90°, from an unlocked position with the lug retracted substantially flush with the window, to a locked position with the lug extending through the window. The cam of the sleeved cam controls positioning of two solid metal balls relative to opposed hemispherical concave notches in the shackle. In the locked position, the cam urges the balls, in opposite directions, into mating engagement with the opposed notches. In the unlocked position, the balls are free to recede from the opposed notches, thereby allowing the shackle to be raised from the body of the lock.

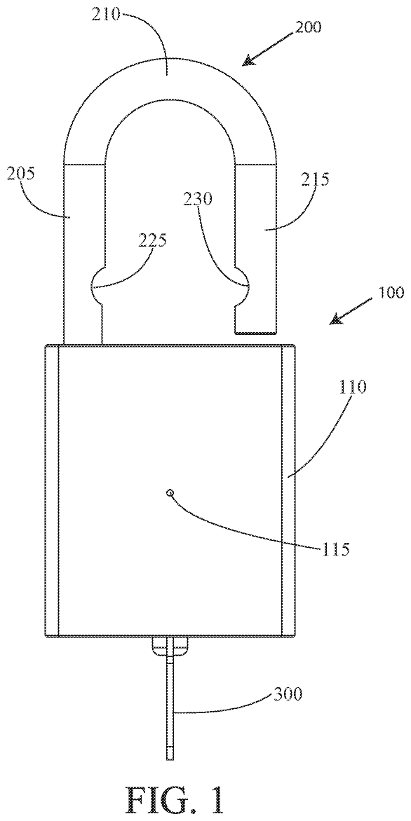

FIG. 1 is a side view of an exemplary padlock 100 in an unlocked configuration according to principles of the invention. The padlock includes a J-shaped shackle 200. The shackle 200 includes a shank 205 leading to a 180° bend 210 (i.e., an intermediate section). The bend 210 leads to a free end 215. The length of the free end 215 is less than the length of the shank 205. The shank 205 and free end 215 are parallel. A pair of notches (e.g., hemispherical concavities) 225, 230 are formed in the shackle 200. One notch 225 is formed in the shank 205. The other notch 230 is formed in the free end 215. The notches 225, 230 are opposing (i.e., opposite each other) and aligned. The shown portions of the shackle 200, except at the notches 225, 230, have the same diameters. Such a shackle may be formed from metal round rod, which is machined to provide notches and then bent to shape.

A lock body 105 provides a housing for internal locking components. In an exemplary embodiment, the body 105 is a one-piece machined structure. In other embodiments the body may be formed of several pieces joined together with rivets, welds and/or other fasteners. A small access port 115 is formed in a back panel 110 of the lock body 105. The port 115 facilitates installation and removal of the lock core by depressing the lug when the padlock is unlocked.

A key 300 engages the lock core (i.e., lock plug with a tubular keyway). The exemplary key 300 is a tubular key, a type of key typically used for vending style locks.

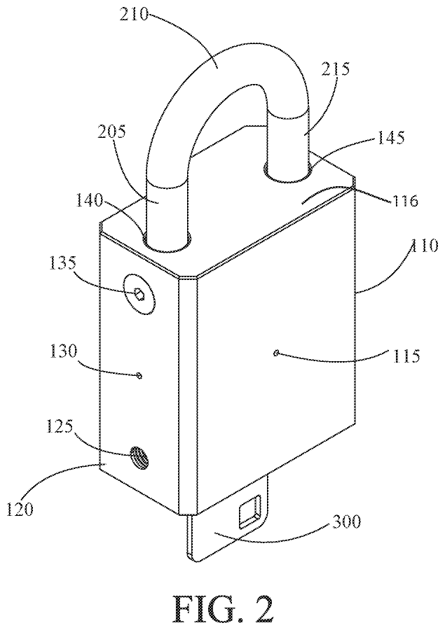

FIG. 2 provides an isometric view of the exemplary padlock 100 in a locked configuration according to principles of the invention. Two openings 140, 145 are provided in the top of 116 of the lock body 105. The openings 140, 145 lead to cylindrical parallel channels in the body 105. The openings 140, 145 and channels extending therefrom have the same diameter, a diameter that is slightly larger than the diameters of the shank 205 and free end 215 of the shackle 200.

Side panel 120 includes a threaded channel 125 for receiving a set screw, which is described below. A small access port 130 is also formed in the side panel 120 of the lock body 105. The port 130, like port 115, facilitates installation and removal of the lock core by depressing the lug when the padlock is unlocked. Threaded plug 135 closes a threaded channel (i.e., a threaded access channel) that leads to a compartment in the body 105 and facilitates assembly.

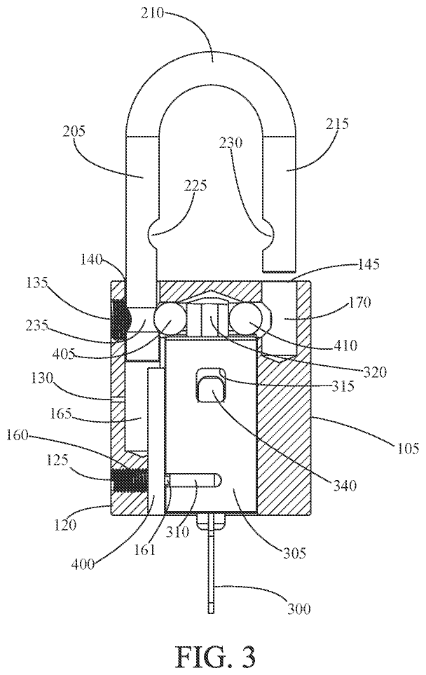

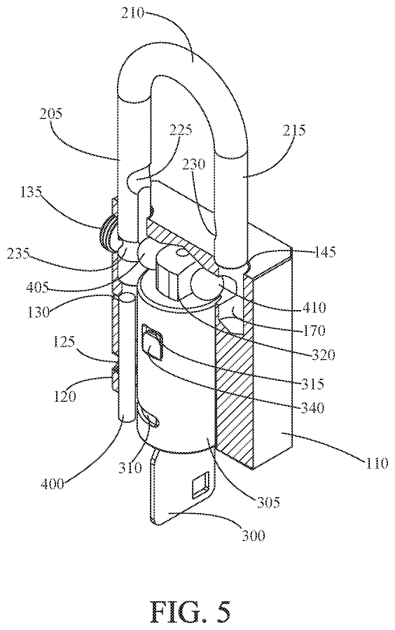

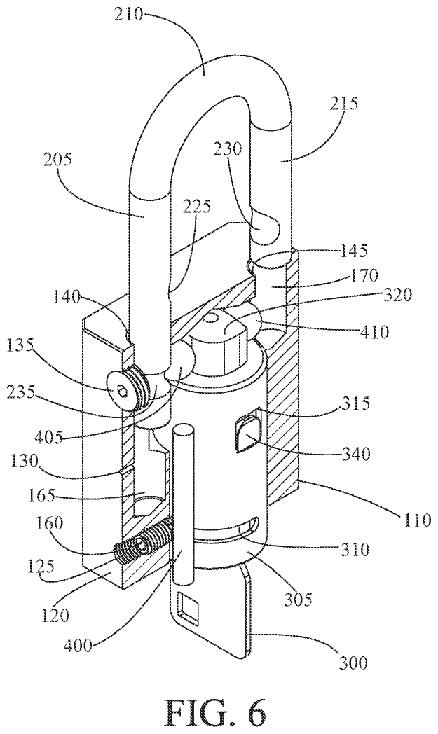

FIGS. 3, 5 and 6 provide partial section views of the exemplary padlock 100 in an unlocked configuration according to principles of the invention. A section of the body 105 is shown to expose interior structure and components. While the body 105 is sectioned, the components are not sectioned.

Parallel shackle channels 165, 170, extend from openings 140 and 145, respectively. The shackle channel 165 that receives the shank 205 of the shackle 200 is longer than the shackle channel 170 that receives the free end 215 of the shackle 200, because the shank 205 is longer than the free end 215. An annular retention groove 235 is provided adjacent to the end of the free end 215 of the shackle 200. The depth of the annular retention groove 235 is less than the depth of notch 225. In the unlocked position, ball 405 sufficiently engages the groove 235 to resist withdrawal of the shackle 200.

A pair of locking members (e.g., aligned balls 405, 410) provide locking and unlocking action. The balls 405, 410 are solid metal balls, such as ball bearings. The diameters of the balls are equal. The radius of each ball is about equal to (or slightly less than) the radius of curvature of notches 225, 230 and groove 235. The balls 405, 410 reside in a channel in the body 105 that extends from threaded port 136. The channel is described below. The balls 405, 410 are disposed between the shank 205 and free end 215 of the shackle 200. A cam 320 of sleeved cam 325 is disposed between the balls 405, 401. Rotation of the cam 320 causes movement of the balls 405, 410 in relation to the shank 205 and free end 215 of the shackle 200. The cam 320 converts rotating motion of the sleeved cam into linear motion of the balls 405, 410.

A sleeved cam 325 includes a sleeve 305, in which a vending style lock 330 is received, and a cam 320. A movable lug 340 of the vending style lock 330 aligns with a window 315 in the sleeve 305. When locked, the lug 340 extends through the window 315. When unlocked, the lug 340 is about flush with the window 315. About flush means flush, proud by less than 1/16″ or extending into the window without extending beyond the exterior surface of the sleeve 305. The sleeve 305 also includes a narrow peripheral fenestration 310 (e.g., a window or a groove) that extends about 90° around the sleeve 305. The fenestration 310 is aligned with threaded channel 125. A tip 161 of a set screw 160 in the threaded channel 125 extends into the fenestration 310, but does not exert force against the sleeve 305 (or the contained vending style lock 330) that would prevent rotation of the sleeve 305 (and the contained vending style lock 330) relative to the set screw 160. The 90° span of the fenestration 310 allows rotation of the sleeve 305 (and the contained vending style lock 330) 90°, from an unlocked position with the lug 340 retracted substantially flush with the window 315, to a locked position with the lug 340 extending through the window 315.

The cam 320 of the sleeved cam 325 controls positioning of the two solid metal balls 405, 410 in relation to opposed hemispherical concave notches 225, 230 in the shackle 200. In the locked position, the cam 320 urges the balls 405, 410, in opposite directions, into mating engagement with the opposed notches 225, 230. In the unlocked position, the balls 405, 410 are free to recede from the opposed notches 225, 230, thereby allowing the shackle 200 to be extended from the body 105 of the lock 100, until a ball 405 engages annular groove 235.

A stop bar 400 extends into the lock body 105, alongside the sleeve 305, past the window 315. The stop bar 400 is fixed in position. The stop bar 400 may be solid, hollow or a bent or rolled sheet, with a round or other cross-section shape. The stop bar 400 limits rotation of the sleeved cam 325 and the contained vending style lock 330 when the lug 340 protrudes through the window 315.

Vending style locks vary. Lugs of some vending style locks cannot be depressed when the lock is in a locked state. Lugs of other vending style locks can be depressed when the lock is in a locked state. The stop bar 400 prevents rotation of the sleeved cam 325 and the contained vending style lock 330 when the vending style lock 330 is in a locked state and the lug 340 protrudes through the window 315. Preventing such rotation prevents depression of the lug 340 by rotating the assembly to a position within the lock body that does not accommodate the extended lug 340. Thus, the stop bar 400 provides protection against attempts to defeat the padlock 100.

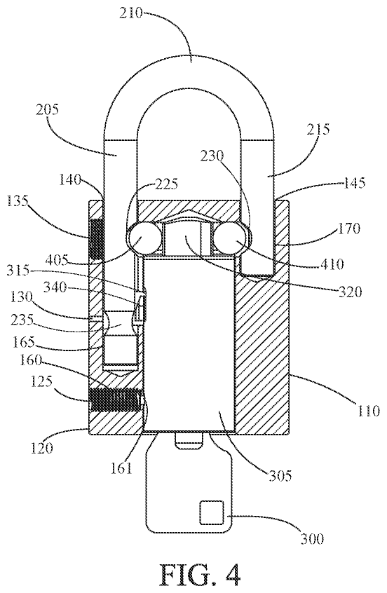

FIG. 4 is partial section view of the exemplary padlock in a locked configuration according to principles of the invention. The stop bar 400 is removed from this figure, to reveal the extended (i.e., locked) position of the lug 340. The lug 340 extends into a compartment in the body 105 aligned with port 130. Cam 320 urges balls 405, 410 into notches 225, 230.

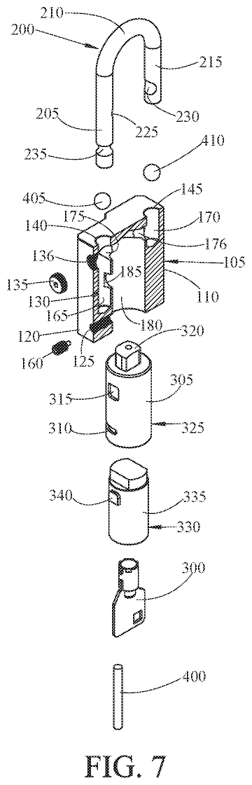

FIG. 7 is an isometric partial section exploded view of the exemplary padlock in an unlocked configuration according to principles of the invention. The vending style lock 330 (i.e., lock core or plug) is shown removed from the sleeved cam 325. The body 335 of the vending style lock 330 fits within the sleeve 305 of the sleeved cam 325.

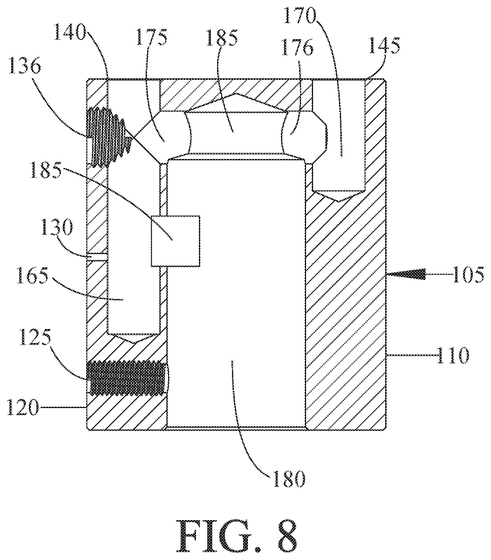

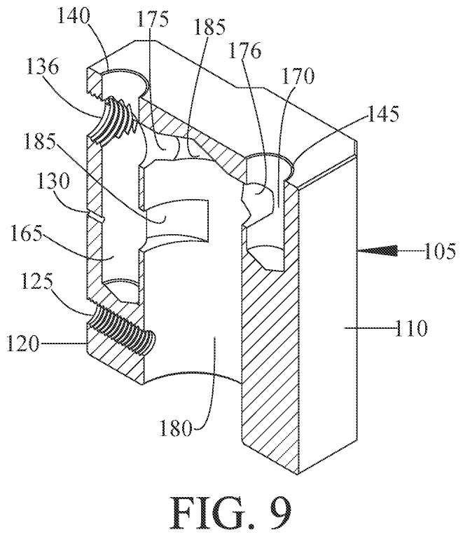

As also shown in FIGS. 8 and 9, features of the exemplary padlock body according to principles of the invention are shown. A primary channel 180 extends from the bottom of the body 105. The primary channel 180 may be bored (e.g., drilled or otherwise machined) in the body 105. The primary channel 180 is sized and shaped to receive the sleeved cam 325 and the contained vending style lock 330.

A lug compartment 185 is formed in a side of the primary channel facing a shackle channel 165, 170, in this exemplary embodiment shackle channel 165 for the shank 205 of the shackle 200. The lug compartment 185 is configured (i.e., sized, shaped and positioned) to receive the lug 340 when extended (i.e., in a locked position or state). The lug compartment 185 may be machined as an undercut. Using a slot cutter or undercutting end mill inserted in the primary channel 180, the lug compartment 185 may be machined in the solid body 105. A ball compartment 175, 176 contains each ball 405, 410. Each ball compartment 175, 176 is machined as an undercut. Using a slot cutter or undercutting end mill inserted in the shackle channel 165, the ball compartment 175 may be machined in the solid body 105. Likewise, using a slot cutter or undercutting end mill inserted in the shackle channel 170, the ball compartment 176 may be machined in the solid body 105. The diameter of the threaded port 136 is at least equal to, and preferably slightly greater than, the diameter of each ball 405, 410. Thus a ball may be inserted through the threaded port 136.

An intermediate channel 185, which is actually an upper portion of the primary channel 180, extends from one ball compartment 175 to the opposite ball compartment 176. The diameter of the bearing channel 185 may be at least equal to, and preferably slightly greater than, the diameter of each ball 405, 410. Thus, a ball 405, 410 may be dropped through threaded port 136 into ball compartment 176.

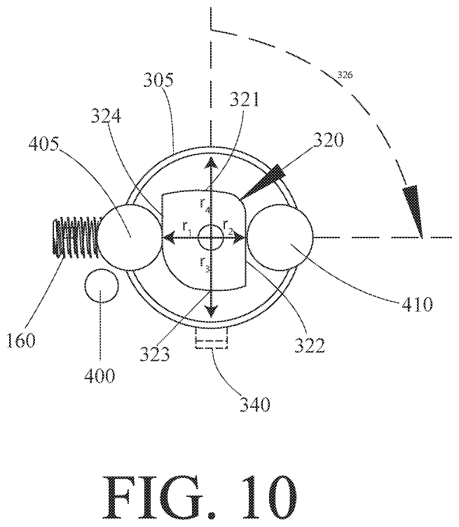

FIG. 10 is a plan view of locking mechanism components of the exemplary padlock 100 according to principles of the invention. The cam 320 is disposed between the balls 405, 410. Opposed substantially flat portions 322, 324 of the cam 320 define the unlocked position of the balls 405, 410. The radii, r₁ and r₂, are not equal. Radius r₁ exceeds r₂. Radius r₁ defines the unlocked position of ball 405. Radius r₂ defines the unlocked position of ball 410. Opposed substantially flat portions 321, 323 of the cam 320 define the locked position of the balls 405, 410. Radius r₃ defines the locked position of ball 405. Radius r₄ defines the locked position of ball 410. Radius r₃ exceeds radius r₁. Radius r₄ exceeds radius r₂. In the locked position, the balls 405, 410 are moved further away from the center of rotation of the cam 320. In the unlocked position, ball 405 moves to a position for engaging groove 235, without engaging notch 225. In the unlocked position, the lug 340 is retracted. When retracted, the lug 340 is about flush with the sleeve 305. In the locked position, the lug 340 extends radially outward through the window 315 of the sleeve 305. In the locked position, the lug 340 is aligned with the set screw, at about the 9 o'clock position in FIG. 10. In the locked position, due to the protruding lug 340, the stop 400 prevents counterclockwise rotation of the sleeve 305 and contained lock 330. In the locked position, the set screw 160 in engagement with the fenestration 310 prevents clockwise rotation of the sleeve 305 and contained lock 330. The dotted arc 326 defines the direction (clockwise) and degree (90°) of rotation from unlocked to locked positions.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A padlock comprising:
a lock body with a bottom and a top, a primary channel extending through the bottom into the lock body, a pair of spaced apart parallel shackle channels extending through the top into the lock body;
a sleeved cam received in the primary channel, the sleeved cam including a tubular sleeve, a cam fixed at an end of the sleeve, a window in the sleeve, and the sleeved cam being rotatable in the primary channel, about a longitudinal axis, from a locked position to an unlocked position;
a vending style lock within the tubular sleeve, the vending style lock including a lug, the lug being movable from a retracted position to an extended position, and the lug being aligned with the window of the sleeve, and the lug being about flush with the window in the retracted position and the lug extending through the window in the extended position;
a lug compartment in the lock body, the lug compartment being aligned with the lug when the sleeved cam is in the locked position, the lug extending into the lug compartment when the lug is in the extended position and the sleeved cam is in the locked position, and the lug not extending into the lug compartment when the lug is in the retracted position;
a shackle, the shackle having a J-shape including a shank, a bend and a free end parallel to the shank, the bend extending from the shank to the free end, the shank and free end of the shackle being at least partially receivable in the pair of shackle channels;
a pair locking members, the cam being disposed between one locking member and the other locking member, and, in the locked position, the cam urging one locking member against the free end and urging the other locking member against the shank of the shackle.

2. The padlock of claim 1, each of the free end and the shank of the shackle including a notch, and the notch of the free end being opposite the notch of the shank and, in the locked position, the notch of the free end and the notch of the shank being aligned with the cam, and, in the locked position, the cam urging one locking member against the notch in the free end and urging the other locking member against the notch in the shank of the shackle.

3. The padlock of claim 2, the notch in the free end being hemispherical, and the notch in the shank each being hemispherical and opposed to the notch in the free end.

4. The padlock of claim 3, wherein the pair of locking members comprise a pair of metal balls.

5. The padlock of claim 4, wherein, in the locked position, the cam urging one locking member against the notch in the free end and urging the other locking member against the notch in the shank of the shackle.

6. The padlock of claim 1, the tubular sleeve further comprising a peripheral fenestration extending about 90° around the tubular sleeve.

7. The padlock of claim 6, the lock body further comprising a threaded channel aligned with the peripheral fenestration.

8. The padlock of claim 7, further comprising a set screw received in the threaded channel and a tip of the set screw extends into the peripheral fenestration.

9. The padlock of claim 8, wherein the tip of the set screw does not exert rotation preventing force against the vending style lock.

10. The padlock of claim 1, the lock body being a solid integrally formed structure, the primary channel being a first bore, each shackle channel of the pair of spaced apart parallel shackle channels being a second bore, and the lug compartment being an undercut in one of the shackle channels of the pair of spaced apart parallel shackle channels.

11. The padlock of claim 1, wherein the vending style lock includes a tubular keyway.

12. The padlock of claim 1, wherein the lock body further comprises a threaded access channel extending, in alignment with the cam, through one of the shackle channels of the pair of spaced apart parallel shackle channels.

13. A padlock comprising:
a lock body with a bottom and a top, a primary channel extending through the bottom into the lock body, a pair of spaced apart parallel shackle channels extending through the top into the lock body;
a sleeved cam received in the primary channel, the sleeved cam including a tubular sleeve, a cam fixed at an end of the sleeve, a window in the sleeve, and the sleeved cam being rotatable in the primary channel, about a longitudinal axis, from a locked position to an unlocked position;
a lock plug within the tubular sleeve, the lock plug being rotatable with the sleeved cam, and the lock plug including a lug, the lug being movable from a retracted position to an extended position, and the lug being aligned with the window of the sleeve, and the lug being about flush with the window in the retracted position and the lug extending through the window in the extended position;
a lug compartment in the lock body, the lug compartment being aligned with the lug when the sleeved cam is in the locked position, the lug extending into the lug compartment when the lug is in the extended position and the sleeved cam is in the locked position, and the lug not extending into the lug compartment when the lug is in the retracted position;
a shackle, the shackle including a shank, an intermediate section, and a free end parallel to the shank, the intermediate section extending from the shank to the free end, the shank and free end of the shackle being at least partially receivable in the pair of shackle channels;
a pair solid metal balls, the cam being disposed between one solid metal ball and the other solid metal ball, and, in the locked position, the cam urging one solid metal ball against the free end and urging the other solid metal ball against the shank of the shackle.

14. The padlock of claim 1, each of the free end and the shank of the shackle including a notch, and the notch of the free end being opposite the notch of the shank and, in the locked position, the notch of the free end and the notch of the shank being aligned with the cam, and, in the locked position, the cam urging one solid metal ball against the notch in the free end and urging the other solid metal ball against the notch in the shank of the shackle, and the notch in the free end being hemispherical, and the notch in the shank each being hemispherical and opposed to the notch in the free end.

15. The padlock of claim 14, wherein, in the locked position, the cam urging one solid metal ball against the notch in the free end and urging the other solid metal ball against the notch in the shank of the shackle.

16. The padlock of claim 1, the tubular sleeve further comprising a peripheral fenestration extending about 90° around the tubular sleeve; and
the lock body further comprising a threaded channel aligned with the peripheral fenestration; and
a set screw received in the threaded channel and a tip of the set screw extends into the peripheral fenestration.

17. The padlock of claim 16, wherein the tip of the set screw does not exert rotation preventing force against the lock plug.

18. The padlock of claim 13, the lock body being a solid integrally formed structure, the primary channel being a first bore, each shackle channel of the pair of spaced apart parallel shackle channels being a second bore, and the lug compartment being an undercut in one of the shackle channels of the pair of spaced apart parallel shackle channels.

19. The padlock of claim 1, wherein the lock plug includes a tubular keyway.

20. The padlock of claim 1, wherein the lock body further comprises a threaded access channel extending, in alignment with the cam, through one of the shackle channels of the pair of spaced apart parallel shackle channels.
